(19) United States
(12) Patent Application Publication
(10) Pub. No.: US 2025/0383888 A1
(43) Pub. Date: Dec. 18, 2025

(54) METHOD FOR GENERATING CONFIGURATION INTERFACES

(71) Applicant: MONTAGE ELECTRONICS (ZHUHAI HENGQIN) CO., LTD., Zhuhai (CN)

(72) Inventors: Qiang LI, Zhuhai (CN); Xuegang XU, Zhuhai (CN); Chunde ZHONG, Zhuhai (CN)

(73) Assignee: MONTAGE ELECTRONICS (ZHUHAI HENGQIN) CO., LTD., Zhuhai (CN)

(21) Appl. No.: 19/194,047

(22) Filed: Apr. 30, 2025

(30) Foreign Application Priority Data
Jun. 13, 2024 (CN) 2024107697782

(51) Int. Cl. G06F 9/445

(52) U.S. Cl. CPC G06F 9/44505

(57) ABSTRACT

A method for generating configuration interfaces is provided. The method comprises loading a UEFI Option ROM driver of an external device through a UEFI of a host device, where the UEFI Option ROM driver is generated based on a UEFI driver and a configuration interface file; dynamically parsing the configuration interface file of the UEFI Option ROM driver using a file parser within the UEFI Option ROM driver to obtain a parsing result, and creating configuration interface options for a UEFI setup menu of the host device based on the parsing result. By utilizing the above method, users can flexibly configure and manage the interfaces of the external device.

### FIELD OF THE INVENTION

The present disclosure relates to the field of external device management technologies, and in particular, to a method for generating configuration interfaces.

### BACKGROUND OF THE INVENTION

In a system that includes a host device and external devices, the collaboration between these components is crucial for the system's overall functionality. In some practical applications, it's necessary to display configuration interface options for the external devices on the host device's setup menu, allowing users to manage the configuration interfaces of the external devices directly through the setup menu. However, current technologies often lack flexibility in configuring and managing these interface options for external devices.

### SUMMARY OF THE INVENTION

Embodiments of the present disclosure provide a method for generating configuration interfaces, allowing for flexible configuration and management of configuration interface options for external devices.

In one embodiment of the present disclosure, the method comprises loading a UEFI Option ROM driver of an external device through a UEFI of a host device, wherein the UEFI Option ROM driver is generated based on a UEFI driver and a configuration interface file; dynamically parsing the configuration interface file of the UEFI Option ROM driver using a file parser within the UEFI Option ROM driver to obtain a parsing result, and creating configuration interface options for a UEFI setup menu of the host device based on the parsing result.

In one embodiment of the present disclosure, the UEFI Option ROM driver is generated by merging the UEFI driver and the configuration interface file of the external device.

In one embodiment of the present disclosure, the generation of the UEFI Option ROM driver by merging the UEFI driver and the configuration interface file comprises: obtaining configuration interface information from the configuration interface file; adding the configuration interface information to the UEFI driver to generate a new UEFI driver; and generating the UEFI Option ROM driver based on the new UEFI driver.

In one embodiment of the present disclosure, the new UEFI driver comprises the UEFI driver, the configuration interface information, and structure information, and the structure information is configured to indicate positions of the UEFI driver and the configuration interface information in the new UEFI driver.

In one embodiment of the present disclosure, the generating of the UEFI Option ROM driver based on the new UEFI driver comprises: signing the new UEFI driver through a signature server to obtain a signed UEFI driver; packaging and compressing the signed UEFI driver to generate the UEFI Option ROM driver.

In one embodiment of the present disclosure, when the host device starts up, the external device maps the UEFI Option ROM driver to a PCI Expansion ROM BAR space, and the UEFI of the host device loads the UEFI Option ROM driver of the external device from the PCI Expansion ROM BAR space.

In one embodiment of the present disclosure, the configuration interface file is generated based on configuration interface information stored in firmware of the external device.

In one embodiment of the present disclosure, the configuration interface information is created based on a unified rule.

In one embodiment of the present disclosure, the configuration interface information comprises a keyword field and a description information field.

In one embodiment of the present disclosure, the description information field comprises location information of each of the configuration interfaces in the configuration interface file, types of the configuration interface options, field information required to generate the configuration interface options of the UEFI setup menu based on the types of the configuration interface options, and/or processing types corresponding to keywords.

In one embodiment of the present disclosure, the configuration interface information is created by: determining the location information of each of the configuration interfaces in the configuration interface file, and utilizing annotations in a unified format to describe the location information of each of the configuration interfaces in the configuration interface file; determining the types of the configuration interface options and the field information required to generate the configuration interface options of the UEFI setup menu based on the types of the configuration interface options; determining the keywords based on the field information; and determining the processing types based on the keywords.

In one embodiment of the present disclosure, the generating of the configuration interface file based on the configuration interface information stored in the firmware of the external device comprises: extracting all configuration interface information created by a unified rule from the firmware of the external device, and merging the configuration interface information into a unified structure; processing description information field comprised in each piece of configuration interface information based on processing types corresponding to keywords, to obtain processed configuration interface information; calculating dynamic information of each of the configuration interfaces in a firmware compiling stage to obtain calculated dynamic information, and adding the calculated dynamic information to the unified structure; and generating the configuration interface file based on the processed configuration interface information.

In one embodiment of the present disclosure, the method further comprises adjusting the configuration interface options of the UEFI setup menu through the configuration interface information in the firmware of the external device.

In the present disclosure, the UEFI of the host device loads the UEFI Option ROM driver of the external device, the file parser within the UEFI Option ROM driver dynamically parses the configuration interface file of the UEFI Option ROM driver to obtain the parsing result, and the configuration interface options for the UEFI setup menu of the host device is created based on the parsing result, allowing users to flexibly manage the configuration interfaces of the external device based on their actual needs.

Additionally, the configuration interface information of the external device can be stored in its firmware. Users can easily adjust the configuration interface options of the UEFI setup menu on the host device by simply modifying the configuration interface information in the firmware, without altering the configuration interface file or the UEFI Option ROM driver of the external device, simplifying the process.

Furthermore, when the host device starts up, its UEFI dynamically loads and executes the UEFI Option ROM driver of the external device, displaying the configuration interface options in the UEFI setup menu. Therefore, when the configuration interface information of the external device changes, the host device will automatically adjust the configuration interface options in the UEFI setup menu, eliminating the need for manual adjustments by the user.

### BRIEF DESCRIPTION OF DRAWINGS

FIG. 1 is a schematic diagram of an application scenario of a method for generating configuration interfaces according to an embodiment of the present disclosure.

FIG. 2 is a flowchart of the method for generating the configuration interfaces according to an embodiment of the present disclosure.

FIG. 3A is a flowchart of generating a configuration interface file according to an embodiment of the present disclosure.

FIG. 3B is a schematic diagram of generating the configuration interface file according to an embodiment of the present disclosure.

FIG. 4A is a flowchart of generating a UEFI Option ROM driver according to an embodiment of the present disclosure.

FIG. 4B is a schematic structural diagram of the UEFI Option ROM driver according to an embodiment of the present disclosure.

FIG. 4C is a flowchart of generating the UEFI Option ROM driver based on a new UEFI driver according to an embodiment of the present disclosure.

### DETAILED DESCRIPTION OF THE INVENTION

The embodiments of the present disclosure will be described below. Those skilled can easily understand other advantages and effects of the present disclosure according to contents disclosed by the specification. The present disclosure can also be implemented or applied through other different specific embodiments. Various details in this specification can also be modified or changed based on different viewpoints and disclosures without departing from the spirit of the present disclosure. It should be noted that the following embodiments and features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the layout of the components can also be more complicated.

When a host device and an external device work together, it's often necessary to display configuration interface options for the external device on the host device's setup menu, allowing users to manage the configuration interfaces of the external device directly through the setup menu, thereby managing the external device. In some technical solutions, the management of the configuration interfaces of the external device can be achieved based on a unified extensible firmware interface (UEFI).

The host device follows UEFI specifications, which include the UEFI and a UEFI setup engine. Through the UEFI setup engine, users can configure the hardware, boot options, time, and other settings of the host device, as well as the interfaces of the external device connected to the host device. The host device can be, for example, a host.

The external device comprises firmware and a UEFI Option ROM driver. The UEFI Option ROM driver can be invoked by the host's firmware during boot to handle the initialization tasks of the external device. The firmware of the external device comprises interfaces for obtaining/setting the configuration interface information of the external device. The external device can be directly attached to the host or connected to the host through slots or USB ports. For example, the external device can be embedded devices. Additionally, the UEFI Option ROM driver provides a UEFI human interface infrastructure (HII) interface between the external device and the host device. The UEFI HII interface can provide the configuration interface options for the configuration interfaces in the UEFI setup menu.

Currently, in the UEFI environment, the UEFI drivers of the external device are packaged into Option ROMs to obtain the UEFI Option ROM driver. The host device completes the loading of the UEFI Option ROM driver during startup through UEFI and initializes the configuration interfaces of the external device. The configuration interface options of the UEFI setup menu are statically generated by visual form representation (VFR) files.

However, in the above technical solutions, the configuration interface options of the UEFI setup menu are highly customized static options, which lack flexibility. Additionally, in these technical solutions, the configuration interfaces and firmware of the external device are highly coupled; that is, when adding, deleting, or modifying the configuration interfaces of the external device, it is necessary to simultaneously modify the UEFI Option ROM driver and firmware.

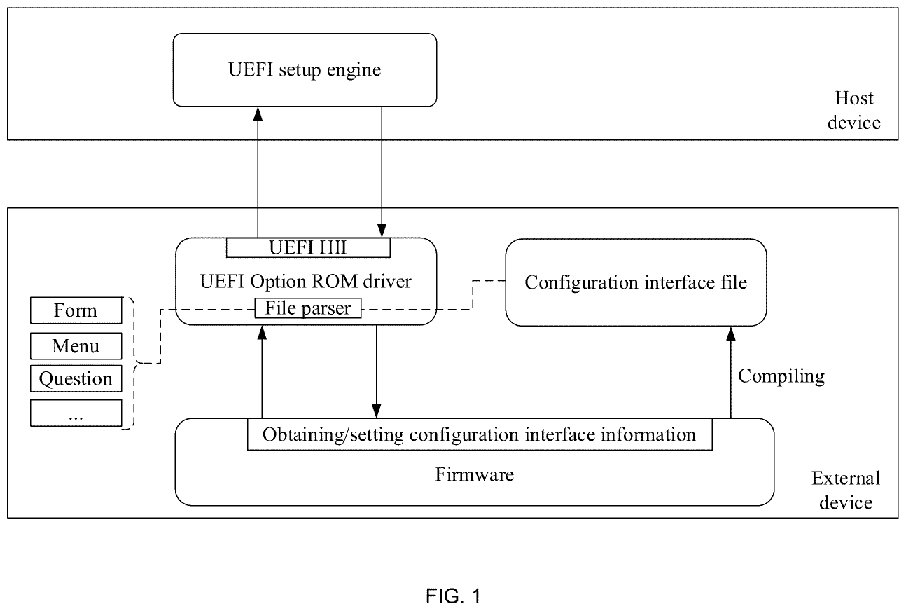

To address these issues, the present disclosure provides a method for generating configuration interfaces. FIG. 1 is a schematic diagram of an application scenario of the method for generating the configuration interfaces. As shown in FIG. 1, configuration interface information stored in firmware of an external device is created according to a unified rule. In a firmware compiling stage, a configuration interface file is generated based on the configuration interface information. A UEFI Option ROM driver of the external device further comprises a file parser, to parse the configuration interface file.

In some embodiments, the configuration interface file may be a YAML file, and the file parser may be a YAML parser.

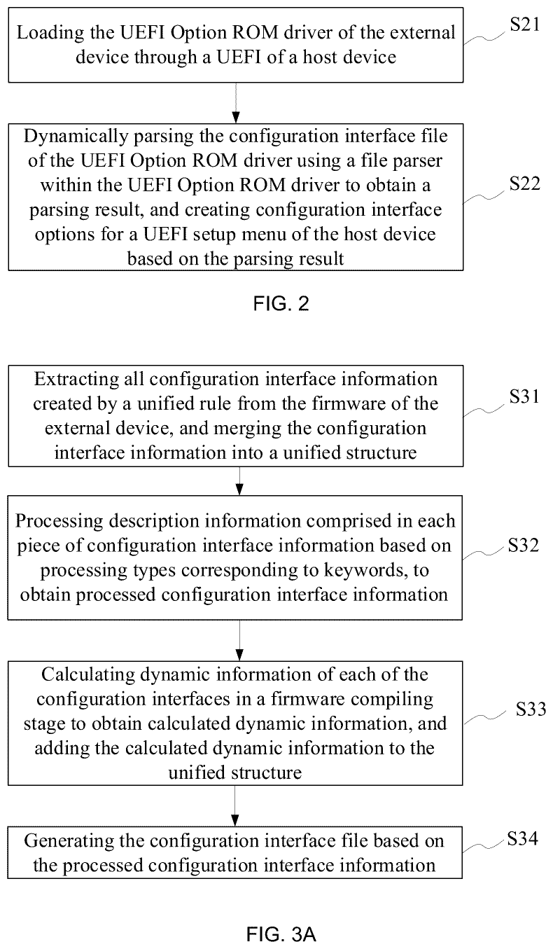

FIG. 2 is a flowchart of the method for generating the configuration interfaces according to an embodiment of the present disclosure. As shown in FIG. 2, the method comprises steps S21-S22.

Step S21 includes: loading the UEFI Option ROM driver of the external device through a UEFI of a host device. The UEFI Option ROM driver comprises a UEFI driver and a configuration interface file of the external device.

In some embodiments, the UEFI Option ROM driver is generated based on the UEFI driver and the configuration interface file. For example, the UEFI Option ROM driver is generated by merging the UEFI driver and the configuration interface file of the external device.

In some embodiments, when the host device starts up, the external device maps the UEFI Option ROM driver to a peripheral-component-interconnect (PCI) Expansion read-only memory (ROM) base-address-register (BAR) space. The UEFI of the host device loads the UEFI Option ROM driver of the external device from the PCI Expansion ROM BAR space.

Step S22 includes: dynamically parsing the configuration interface file of the UEFI Option ROM driver using a file parser within the UEFI Option ROM driver to obtain a parsing result, and creating configuration interface options for a UEFI setup menu of the host device based on the parsing result.

In some embodiments, the configuration interface file is generated based on the configuration interface information stored in the firmware of the external device. The following describes the configuration interface information and how to generate the configuration interface file based on the configuration interface information.

In some embodiments, the configuration interface information for some or all configuration interfaces of the external device can be created in the firmware of the external device according to the unified rule. The configuration interface information comprises a keyword field and a description information field (or, description information).

In some embodiments, the description information may comprise location information of each of the configuration interfaces in the configuration interface file, types of the configuration interface options, field information required to generate the configuration interface options of the UEFI setup menu based on the types of the configuration interface options, and/or processing types corresponding to keywords. The location information may comprise start location information and end location information. In practical applications, annotations in a unified format are utilized to describe the location information of each of the configuration interfaces in the configuration interface file, which allows for quick identification of the corresponding configuration interface when parsing the configuration interface file later. The types of the configuration interface options may comprise subpage types, optional types, numeric types, and the like.

In some embodiments, the configuration interface information is created by:
determining the location information of each of the configuration interfaces in the configuration interface file, and utilizing the annotations in the unified format to describe the location information of each of the configuration interfaces in the configuration interface file, and the annotations in the unified format ensure that only the configuration interface information is extracted during compilation and parsing;
determining the types of the configuration interface options and the field information required to generate the configuration interface options of the UEFI setup menu based on the types of the configuration interface options;
determining the keywords based on the field information, and when modifying or adding the configuration interfaces, each interface's keywords should be unique, and the keywords for interfaces of the same type should remain consistent; and
determining the processing types based on the keywords.

In the firmware compiling stage, a configuration interface file is generated based on the configuration interface information. Scripts can be used to extract the configuration interface information from source codes of the external device's firmware, and the configuration interface file is then generated based on the extracted configuration interface information.

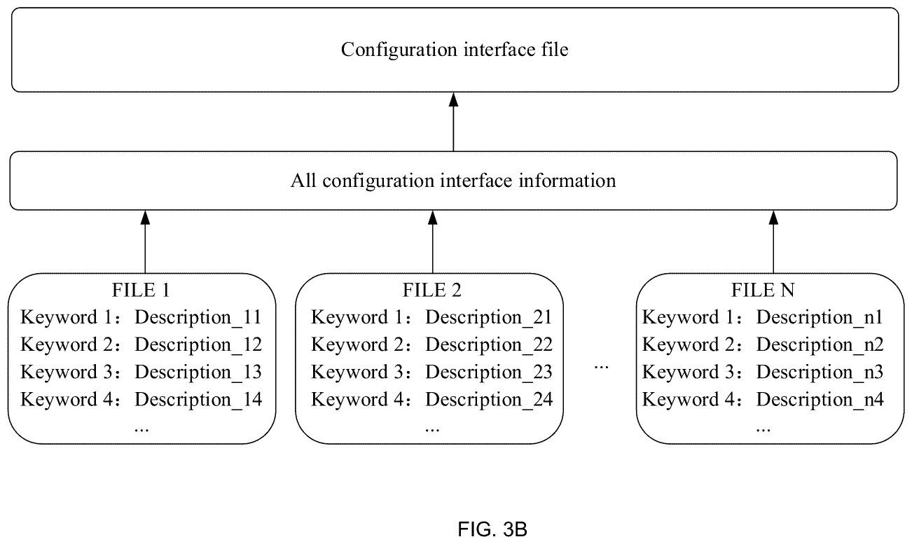

FIG. 3A is a flowchart of generating the configuration interface file based on the configuration interface information stored in the firmware of the external device. As shown in FIG. 3A, the generating of the configuration interface file based on the configuration interface information stored in the firmware of the external device includes steps S31-S34.

Step S31 includes: extracting all configuration interface information created by a unified rule from the firmware of the external device, and merging the configuration interface information into a unified structure. The unified structure can be configured to organize and store collections of different data types, allowing multiple different types of variables to be combined into a single logical unit for organization and management within a program. Since all configuration interface information is merged into the unified structure, the offset of each piece of configuration interface information is unique, and the offsets of different pieces of configuration interface information are distinct. In UEFI HII, question identifiers (IDs) are used to uniquely identify the configuration interface options. Each configuration interface option is assigned a unique question ID for identification and differentiation in the UEFI setup menu. Therefore, in the present disclosure, the offset of each piece of configuration interface information can be used as its question ID in UEFI HII, allowing the host device to obtain and set the configuration interface options of the external device.

Step S32 includes: processing description information comprised in each piece of configuration interface information based on processing types corresponding to keywords, to obtain processed configuration interface information.

Once the keywords of the configuration interface information and the processing types corresponding to the keywords are determined, the description information in each piece of configuration interface information can be directly processed. In some embodiments, regular expressions can be used to handle the description information in each piece of configuration interface information.

Step S33 includes: calculating dynamic information of each of the configuration interfaces in a firmware compiling stage to obtain calculated dynamic information, and adding the calculated dynamic information to the unified structure. The dynamic information may include offsets, widths, default values, etc.

Step S34 includes: generating the configuration interface file based on the processed configuration interface information.

FIG. 3B shows an example of generating the configuration interface file. As shown in FIG. 3B, each of FILE 1, FILE 2, . . . , and FILE N comprises multiple pieces of configuration interface information, and all configuration interface information from these files can be merged into the unified structure to obtain the configuration interface file.

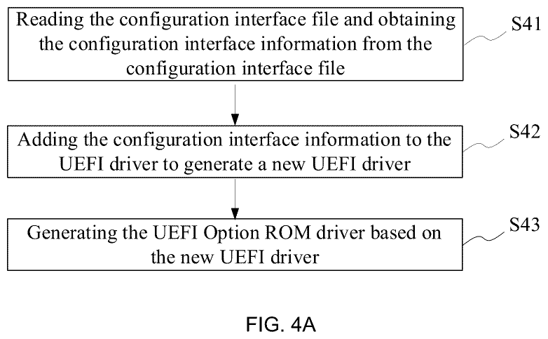

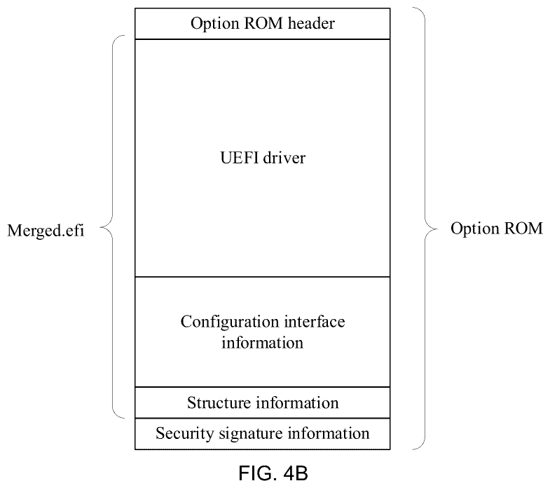

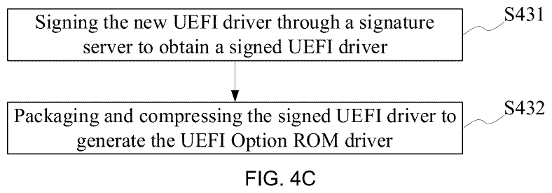

FIG. 4A is a flowchart of generating the UEFI Option ROM driver by merging the configuration interface file and the UEFI driver of the external device. As shown in FIG. 4A, the generation of the UEFI Option ROM driver comprises steps S41-S43.

Step S41 includes: reading the configuration interface file and obtaining the configuration interface information from the configuration interface file.

Step S42 includes: adding the configuration interface information to the UEFI driver to generate a new UEFI driver (Merged.efi).

In some embodiments, the configuration interface information can be added to the external device's UEFI driver afterward.

In some embodiments, after adding the configuration interface information, a location information field of the configuration interface information can be appended to facilitate the subsequent extraction of configuration interface information from the UEFI Option ROM driver.

In some embodiments, the new UEFI driver is structured as shown in FIG. 4B, including the UEFI driver, the configuration interface information, and structure information. The structure information is configured to indicate positions of the UEFI driver and the configuration interface information in the new UEFI driver.

Step S43 includes: generating the UEFI Option ROM driver based on the new UEFI driver. For example, the new UEFI driver can be packaged and compressed using extensible firmware interface (EFI) tools to generate the UEFI Option ROM driver. By compressing the configuration interface information and the UEFI driver together, storage space utilization is effectively improved.

Referring to FIG. 4C, in some embodiments, the generating of the UEFI Option ROM driver based on the new UEFI driver comprises steps S431-S432.

Step S431: includes signing the new UEFI driver through a signature server to obtain a signed UEFI driver. The signature server provides digital signature services to ensure the new UEFI driver is not tampered with and to authenticate the source of the data. For example, as shown in FIG. 4B, the UEFI Option ROM driver further comprises security signature information, which can be used for secure boot.

Step S432: includes packaging and compressing the signed UEFI driver to generate the UEFI Option ROM driver. The structure of the UEFI Option ROM driver, as shown in FIG. 4B, comprises an Option ROM header, the Merged.efi, and the security signature information.

In some embodiments, the method further comprises adjusting the configuration interface options of the UEFI setup menu through the configuration interface information in the firmware of the external device. Specifically, users can add or modify the configuration interface information in the firmware. During the firmware compiling stage, the external device generates the configuration interface file based on the added/modified configuration interface information, and merges the configuration interface file with the external device's UEFI driver to create the UEFI Option ROM driver. When the host device starts up, the external device maps the UEFI Option ROM driver to the PCI Expansion ROM BAR space. The UEFI of the host device loads and executes the UEFI Option ROM driver from the PCI Expansion ROM BAR space. By dynamically parsing the UEFI Option ROM driver of the external device, the host device can obtain the added/modified configuration interface information and generate the configuration interface options of the UEFI setup menu through the configuration interface information in the firmware of the external device.

As described above, the configuration interface options of the UEFI setup menu are dynamically generated and adjustable. Users can adjust the configuration interface options simply by modifying the configuration interface information in the external device's firmware.

In summary, the configuration interface information is created based on the unified rule. For other devices that create configuration interface information based on the same or similar rules, the method of the present disclosure offers high portability and reusability, significantly reducing the development cost and cycle of the UEFI Option ROM for related devices. Additionally, by storing the configuration interface information in the firmware of the external device, the method of the present disclosure allows for the adjustment of the configuration interface options of the UEFI setup menu by modifying the configuration interface information in the external device's firmware, which solves the problem in current technology where adding, deleting, or modifying the configuration interfaces of the external device requires synchronous adjustments to the configuration interface options of the UEFI setup menu.

The scope of the method for generating the configuration interfaces described in the present disclosure is not limited to the sequence of operations listed herein. Any scheme realized by adding or subtracting operations or replacing operations of the traditional techniques according to the principle of the present disclosure is included in the scope of the present disclosure.

The ordinary technical personnel in this field should further realize that the units and algorithm steps of each example described in combination with the embodiments disclosed here can be implemented by electronic hardware, computer software, or a combination of both. In the above description, each example's composition and steps have been described generally based on functions, so as to clearly illustrate the interchangeability of hardware and software. Whether these functions are executed by hardware or software depends on the specific application and design constraints of the technical solution. Professional technicians can use different methods to implement the functions described for each specific situation, but such implementation should not be considered beyond the scope of the present disclosure.

The above-mentioned embodiments only exemplarily illustrate the principles and effects of the present disclosure, but are not used to restrict the present disclosure. Modifications or variations of the above-described embodiments may be made by those skilled in the art without departing from the spirit and scope of the present disclosure. Therefore, all equivalent modifications or changes made by those who have common knowledge in the art without departing from the spirit and technical concept disclosed by the present disclosure shall be still covered by the claims of the present disclosure.

1. A method for generating configuration interfaces, comprising:
loading a UEFI Option ROM driver of an external device through a UEFI of a host device, wherein the UEFI Option ROM driver is generated based on a UEFI driver and a configuration interface file; and
dynamically parsing the configuration interface file of the UEFI Option ROM driver using a file parser within the UEFI Option ROM driver to obtain a parsing result, and creating configuration interface options for a UEFI setup menu of the host device based on the parsing result.

2. The method according to claim 1, wherein the UEFI Option ROM driver is generated by merging the UEFI driver and the configuration interface file of the external device.

3. The method according to claim 2, wherein the generation of the UEFI Option ROM driver by merging the UEFI driver and the configuration interface file comprises:
obtaining configuration interface information from the configuration interface file;
adding the configuration interface information to the UEFI driver to generate a new UEFI driver; and
generating the UEFI Option ROM driver based on the new UEFI driver.

4. The method according to claim 3, wherein the new UEFI driver comprises the UEFI driver, the configuration interface information, and structure information, and the structure information is configured to indicate positions of the UEFI driver and the configuration interface information in the new UEFI driver.

5. The method according to claim 3, wherein the generating of the UEFI Option ROM driver based on the new UEFI driver comprises:
signing the new UEFI driver through a signature server to obtain a signed UEFI driver;
packaging and compressing the signed UEFI driver to generate the UEFI Option ROM driver.

6. The method according to claim 1, wherein when the host device starts up, the external device maps the UEFI Option ROM driver to a PCI Expansion ROM BAR space, and the UEFI of the host device loads the UEFI Option ROM driver of the external device from the PCI Expansion ROM BAR space.

7. The method according to claim 1, wherein the configuration interface file is generated based on configuration interface information stored in firmware of the external device.

8. The method according to claim 7, wherein the configuration interface information is created based on a unified rule.

9. The method according to claim 7, wherein the configuration interface information comprises a keyword field and a description information field.

10. The method according to claim 9, wherein the description information field comprises location information of each of the configuration interfaces in the configuration interface file, types of the configuration interface options, field information required to generate the configuration interface options of the UEFI setup menu based on the types of the configuration interface options, and/or processing types corresponding to keywords.

11. The method according to claim 8, wherein the configuration interface information is created by:
determining the location information of each of the configuration interfaces in the configuration interface file, and utilizing annotations in a unified format to describe the location information of each of the configuration interfaces in the configuration interface file;
determining the types of the configuration interface options and the field information required to generate the configuration interface options of the UEFI setup menu based on the types of the configuration interface options;
determining the keywords based on the field information; and
determining the processing types based on the keywords.

12. The method according to claim 7, wherein the generating of the configuration interface file based on the configuration interface information stored in the firmware of the external device comprises:
extracting all configuration interface information created by a unified rule from the firmware of the external device, and merging the configuration interface information into a unified structure;
processing description information field comprised in each piece of configuration interface information based on processing types corresponding to keywords, to obtain processed configuration interface information;
calculating dynamic information of each of the configuration interfaces in a firmware compiling stage to obtain calculated dynamic information, and adding the calculated dynamic information to the unified structure; and
generating the configuration interface file based on the processed configuration interface information.

13. The method according to claim 7, further comprising adjusting the configuration interface options of the UEFI setup menu through the configuration interface information in the firmware of the external device.
